(19) United States
(12) Patent Application Publication
(10) Pub. No.: US 2026/0037712 A1
(43) Pub. Date: Feb. 5, 2026

(54) DEFECT CANDIDATE DETECTION DEVICE AND OPERATION METHOD THEREOF

(71) Applicant: Samsung Electronics Co., Ltd., Suwon-si (KR)

(72) Inventors: Wook KIM, Suwon-si (KR); Jiwon JEONG, Suwon-si (KR)

(21) Appl. No.: 19/204,999

(22) Filed: May 12, 2025

(30) Foreign Application Priority Data
Aug. 2, 2024 (KR) 10-2024-0102960

(51) Int. Cl. G06F 30/398; G06F 119/22

(52) U.S. Cl. CPC G06F 30/398; G06F 2119/22

(57) ABSTRACT

A defect candidate detection device may include a processor configured to execute computer program instructions, the processor including: a yield prediction model configured to receive a plurality of process data and generate a predicted yield data indicating a predicted yield of a wafer based on the plurality of process data, a yield prediction model analysis circuit configured to generate a yield contribution data based on the plurality of process data and the predicted yield data, where the yield contribution data indicates a degree of influence on a yield of the wafer by each of the plurality of process data, and a defect-causing factor detection circuit that is configured to detect a defect candidate data among the plurality of process data based on the plurality of process data and the yield contribution data and is configured to selectively control a process facility based on the defect candidate data.

### CROSS-REFERENCE TO RELATED APPLICATION

This application claims priority to and the benefit of Korean Patent Application No. 10-2024-0102960 filed in the Korean Intellectual Property Office on Aug. 2, 2024, the entire contents of which is incorporated herein by reference.

### TECHNICAL FIELD

The present disclosure provides a defect candidate detection device and an operation method thereof.

### BACKGROUND

A semiconductor manufacturing process includes several steps (e.g., hundreds of steps), and at the last stage or step, a final inspection is performed to measure the yield of the produced wafers. The yield of a wafer is the percentage of good chips among the total chips in the wafer.

When the yield of a semiconductor is low, various process data may be used in order to analyze the cause of the defect that caused the low yield. Based on various process data, it is possible to analyze whether problems occur frequently in wafers produced on specific production equipment, whether problems occur frequently at specific times, or whether problems occur frequently under specific production conditions. Meanwhile, because the factors affecting wafer yield in the semiconductor manufacturing process are so diverse, it is difficult to analyze all process data.

### SUMMARY

The present disclosure intends to detect the cause of yield reduction during a semiconductor manufacturing process.

A defect candidate detection device may include a processor configured to execute computer program instructions, the processor including: a yield prediction model configured to receive a plurality of process data and generate a predicted yield data indicating a predicted yield of a wafer based on the plurality of process data, a yield prediction model analysis circuit configured to generate a yield contribution data based on the plurality of process data and the predicted yield data, where the yield contribution data indicates a degree of influence on a yield of the wafer by each of the plurality of process data, and a defect-causing factor detection circuit configured to detect a defect candidate data among the plurality of process data based on the plurality of process data and the yield contribution data, where the defect candidate data corresponds to a reduction of the yield of the wafer, and where the defect-causing factor detection circuit is configured to selectively control a process facility based on the defect candidate data, the process facility comprising equipment that performs or monitors a semiconductor manufacturing process.

An operation method of a defect candidate detection device may include executing, by at least one processor, computer program instructions to perform operations including: generating a first process trend indicating a time-series variation of a first process data among a plurality of process data, generating a first contribution trend indicating a time-series variation of a yield contribution indicating a degree of influence on a yield of a wafer by the first process data, determining whether the first process trend satisfies a change condition, determining whether the first contribution trend rapidly satisfies the change condition, determining the first process data is a defect candidate data when the first process trend and the first contribution trend satisfy the change condition, where the defect candidate data corresponds to a reduction of the yield of the wafer, and selectively controlling a process facility based on the defect candidate data, the process facility including equipment that performs or monitors a semiconductor manufacturing process.

A defect candidate detection system may include a process facility configured to generate process data indicating at least one of an operation state and a measurement value of the process facility, the process facility including equipment that performs or monitors a semiconductor manufacturing process, and a defect detection device configured to: generate predicted yield data indicating a predicted yield of a wafer based on the process data, generate yield contribution data indicating a degree of influence on a yield of the wafer by the process data based on the process data and the predicted yield data, determine whether the process data is a defect candidate data based on a first contribution trend indicating a first process trend and based on a time-series variation of the yield contribution data indicating a time-series variation of the process data, where the defect candidate data corresponds to a reduction of the yield of the wafer, and selectively control the process facility based on the defect candidate data.

### BRIEF DESCRIPTION OF THE DRAWINGS

FIG. 1 is a drawing showing a defect candidate detection system according to some embodiments.

FIG. 2 is a drawing showing a defect candidate detection device according to some embodiments.

FIG. 3 is a flowchart showing an operation of a defect-causing factor detection circuit according to some embodiments.

FIG. 4 is a flowchart showing a step S305 in FIG. 3.

FIG. 5 is a flowchart showing a step S307 in FIG. 3.

FIG. 6 is a graph showing data generated by a defect candidate detection device according to some embodiments over time.

FIG. 7 is a graph illustrating a contribution trend over time.

FIG. 8 is a graph illustrating a contribution trend over time.

FIG. 9 is a graph illustrating a contribution trend over time.

FIG. 10 is a block diagram showing an electronic device according to some embodiments.

### DETAILED DESCRIPTION

In the following detailed description, only certain embodiments of the present disclosure have been shown and described, simply by way of illustration. As those skilled in the art would realize, the described embodiments may be modified in various different ways, all without departing from the scope of the present disclosure.

Accordingly, the drawings and description are to be regarded as illustrative in nature and not restrictive. Like reference numerals designate like elements throughout the specification. In the flowchart described with reference to the drawings, the operation order may be changed, several operations may be merged, certain operations may be divided, and particular operations may not be performed.

In addition, expressions written in the singular may be construed in the singular or plural unless an explicit expression such as “one” or “single” is used. Terms including ordinal numbers such as first, second, and the like will be used only to describe various components, and are not to be interpreted as limiting these components. These terms may be used for the purpose of distinguishing one component from other components. In addition, unless explicitly described to the contrary, the word “comprises”, and variations such as “comprises” or “comprising”, will be understood to imply the inclusion of stated elements but not the exclusion of any other elements. As used herein, the phrase “at least one of A, B, and C” refers to a logical (A OR B OR C) using a non-exclusive logical OR, and should not be construed to mean “at least one of A, at least one of B and at least one of C.” As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements and/or components, but do not preclude the presence or addition of one or more other features, steps, operations, elements, components and/or groups thereof. The term “and/or” includes any and all combinations of one or more of the associated listed items. The term “connected” may be used herein to refer to a physical and/or electrical connection and may refer to a direct or indirect physical and/or electrical connection.

The present disclosure has been described herein with reference to flowchart and/or block diagram illustrations of methods, systems, and devices in accordance with example embodiments of the present disclosure. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, are configured to implement the functions specified in the flowchart and/or block diagram block or blocks.

These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks

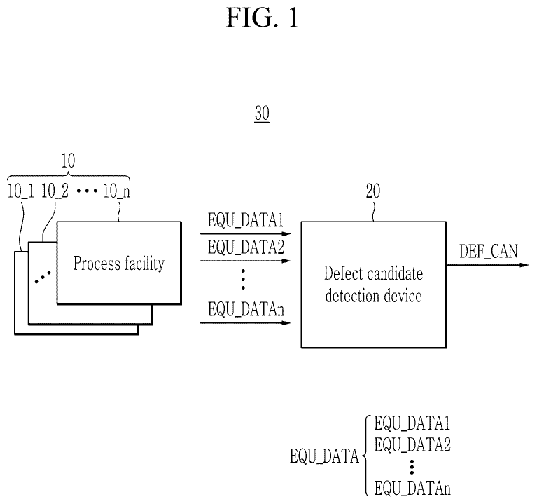

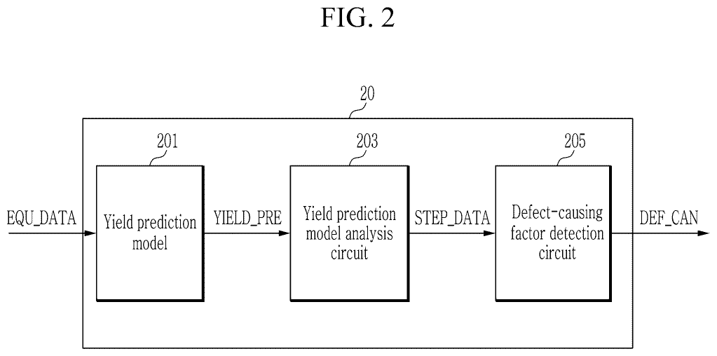

FIG. 1 is a drawing showing a defect candidate detection system according to some embodiments. FIG. 2 is a drawing showing a defect candidate detection device according to some embodiments.

A defect detection system 30 may be a system for detecting defect candidates causing a low yield during a semiconductor manufacturing process.

As shown in FIG. 1, the defect detection system 30 may include a plurality of process facilities 10 (10_1, 10_2, . . . , 10_n) and a defect candidate detection device 20.

A semiconductor manufacturing process to produce a single finished semiconductor product may include numerous unit processes. Accordingly, multiple process facilities 10 to satisfy a high level of precision can be placed in a semiconductor production line.

The plurality of process facilities 10 may include equipment that performs the semiconductor manufacturing process according to a planned process sequence. For example, the plurality of process facilities 10 may include equipment for a photo process, equipment for etching, equipment for chemical mechanical polishing (CMP), chemical vapor deposition (CVD) equipment, sputtering equipment, etching equipment, measuring equipment, or the like.

In some embodiments, the plurality of process facilities 10 may include a process monitoring apparatus. For example, the plurality of process facilities 10 may include equipment for measuring the critical dimension (CD), thickness, height, or the like, of a wafer.

Each of the plurality of process facilities 10 may generate process data EQU_DATA (EQU_DATA1, EQU_DATA2, . . . , EQU_DATAn) that indicate an operation state of that process facility and/or a measurement value measured by that process facility. For example, a first process facility 10_1 among the plurality of process facilities 10 may generate a first process data EQU_DATA1. In some embodiments, a plurality of process data EQU_DATA may include log data obtained during the semiconductor manufacturing process, for example, in-chamber gas pressure, chamber temperature, or the like. In some embodiments, the process data EQU_DATA may include sensor data measured by the process monitoring apparatus during the semiconductor manufacturing process, for example, the critical dimension, thickness, height, or the like, of the wafer.

The defect candidate detection device 20 may detect a factor having the possibility of reducing the yield during the semiconductor manufacturing process. The defect candidate detection device 20 may detect a defect candidate data DEF_CAN based on the plurality of process data EQU_DATA. The defect candidate data DEF_CAN may be a process data that may be a cause of yield reduction among the plurality of process data EQU_DATA.

Referring to FIG. 2 together, the defect candidate detection device 20 may include a yield prediction model (also referred to herein as a yield prediction model circuit) 201, a yield prediction model analysis circuit 203, and a defect-causing factor detection circuit 205.

The yield prediction model 201 may receive the plurality of process data EQU_DATA from the plurality of process facilities 10, and may output a predicted yield data YIELD_PRE corresponding to the received plurality of process data EQU_DATA. A predicted yield data YIELD_DATA may indicate the yield of the wafer manufactured by the plurality of process facilities 10 generating the plurality of process data EQU_DATA. The yield prediction model 201 may be a neural network model trained to output the predicted yield data YIELD_PRE that indicates a yield of the wafer predicted corresponding to the plurality of process data EQU_DATA.

In some embodiments, the yield prediction model 201 may be a black-box model. The black-box model may be a model designed with several parameters and layers that its internal structure is not intuitively understandable. In some embodiments, the black-box model may be a machine learning model, for example, a deep learning model. For example, the yield prediction model 201 may use at least one of Adaptive Boosting (AdaBoost), Gradient Boosting Machine (GBM), extra Gradient Boosting (XGBoost), Light Gradient Boosting (LightGBM), long short-term memory (LSTM), deep neural network (DNN), convolutional neural network (CNN), recurrent neural network (RNN), bidirectional recurrent deep neural network (BRDNN), deep knowledge tracing (DKT), Dynamic Key-Value Memory Networks (DKVMN), and/or SAKT (Self-Attentive Knowledge Tracing).

In some embodiments, the yield prediction model 201 may be a decision tree model. The decision tree model can be an algorithm that finds rules in data through learning and creates tree-based classification rules. For example, the decision tree model may be an algorithm that automatically finds “if else” from among a plurality of data and creates a rule for prediction.

In some embodiments, the yield prediction model 201 may include at least one machine learning model and at least one decision tree model. Meanwhile, the present disclosure is not limited thereto, and the yield prediction model 201 may use any appropriate neural network model.

The yield prediction model 201 may transfer the predicted yield data YIELD_PRE corresponding to the plurality of process data EQU_DATA to the yield prediction model analysis circuit 203.

The yield prediction model analysis circuit 203 may calculate a yield contribution with respect to each of the plurality of process data EQU_DATA based on the plurality of process data EQU_DATA and the predicted yield data YIELD_PRE. The yield contribution may indicate a degree of influence on the yield of the wafer by each of the plurality of process data EQU_DATA. For example, when the first process data has a first yield contribution, and a second process data has a second yield contribution having a lower value than the first yield contribution, the influence of the first process data on manufacturing one wafer may be greater than that of the second process data. That is, in the case that the first process data is wrong, the possibility of having lower yield of the wafer may be higher than in the case that the second process data is wrong.

In some embodiments, for post-hoc analysis, the yield prediction model analysis circuit 203 may apply the explainable artificial intelligence (explainable AI, xAI) technique to the yield prediction model 201. The yield prediction model analysis circuit 203 may convert the yield prediction model 201 to a glass-box model by applying the XAI technique to the yield prediction model 201. Here, the glass-box model may be an artificial intelligence model that is a model of which all parameters may be recognized, and decision-making process may be perceived.

In some embodiments, the yield prediction model analysis circuit 203 may apply Shapley Additive explanations (SHAP) technique using a Shapley value, Local Interpretable Model-Agnostic Explanation (LIME) technique, or the like to the yield prediction model 201. Meanwhile, the present disclosure is not limited thereto, and the yield prediction model analysis circuit 203 may apply an appropriately explainable artificial intelligence technique according to the type of the yield prediction model 201. For example, when the yield prediction model 201 includes a DNN model, the yield prediction model analysis circuit 203 may apply a DeepExplainer and GradientExplainer technique, or the like to the yield prediction model 201. When the yield prediction model 201 uses the decision tree model, the yield prediction model analysis circuit 203 may apply a TreeExplainer technique or the like to the yield prediction model 201.

The yield prediction model analysis circuit 203 may obtain a yield contribution data STEP_DATA indicating a causal relationship between the plurality of process data EQU_DATA and the predicted yield data YIELD_PRE output by the yield prediction model 201 by applying the explainable artificial intelligence (explainable AI, xAI) technique to the yield prediction model 201. For example, the yield contribution data STEP_DATA may include the contribution between the first process data and the predicted yield data YIELD_PRE among the plurality of process data EQU_DATA.

The yield prediction model analysis circuit 203 may transfer the yield contribution data STEP_DATA to the defect-causing factor detection circuit 205.

The defect-causing factor detection circuit 205 may detect the defect candidate data DEF_CAN from among the plurality of process data EQU_DATA based on the plurality of process data EQU_DATA and the yield contribution data STEP_DATA.

In some embodiments, the defect-causing factor detection circuit 205 may detect or identify the process data, in which a trend of the process data and a trend of the yield contribution data of that process data rapidly changes (e.g., satisfies a change condition) at a specific time point, as the defect candidate data DEF_CAN. As used herein, data or trends that “rapidly change” or “satisfy a change condition” refer to data or trends having, for at least one time point, a value that is outside of a threshold range and/or is greater/less than a threshold value. The trend with respect to each of the plurality of process data EQU_DATA may indicate a time-series variation of the corresponding process data. The trend with respect to each of the yield contribution data STEP_DATA may indicate a time-series variation of a corresponding yield contribution.

In more detail, the defect-causing factor detection circuit 205 may generate the trend with respect to each of the plurality of process data EQU_DATA. The defect candidate detection device 20 may detect a process data that deviates from a predetermined reference trend, with respect to each of the plurality of process data EQU_DATA among the plurality of process data EQU_DATA. For example, when the first process data among the plurality of process data EQU_DATA has a value that deviates from the range of the reference trend, i.e., between an upper limit value and a lower limit value of the reference trend, the defect candidate detection device 20 may determine that it deviates from the reference trend.

The defect-causing factor detection circuit 205 may generate the trend of the yield contribution data STEP_DATA with respect to each of the plurality of process data EQU_DATA. The defect candidate detection device 20 may detect the process data that deviates from the predetermined reference trend with respect to each of the plurality of yield contributions, among a plurality of yield contributions with respect to each of the plurality of process data EQU_DATA. For example, when a yield contribution of the first process data among the plurality of process data EQU_DATA has a value that deviates from the range of the reference trend, i.e., between an upper limit value and a lower limit value of the reference trend, the defect candidate detection device 20 may determine that it deviates from the reference trend.

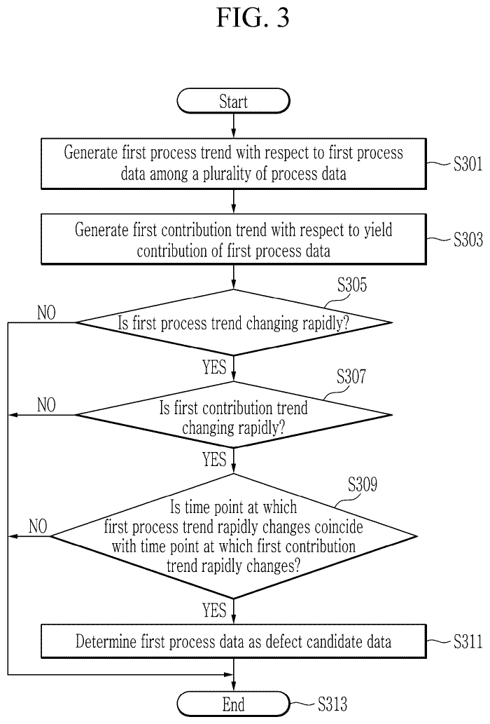

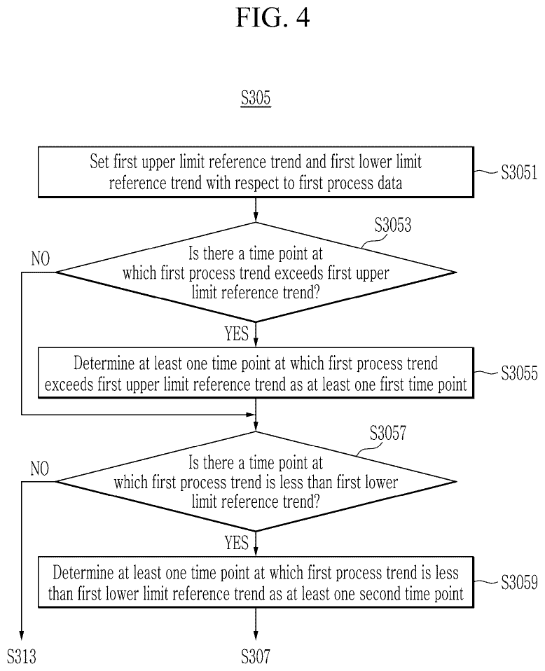

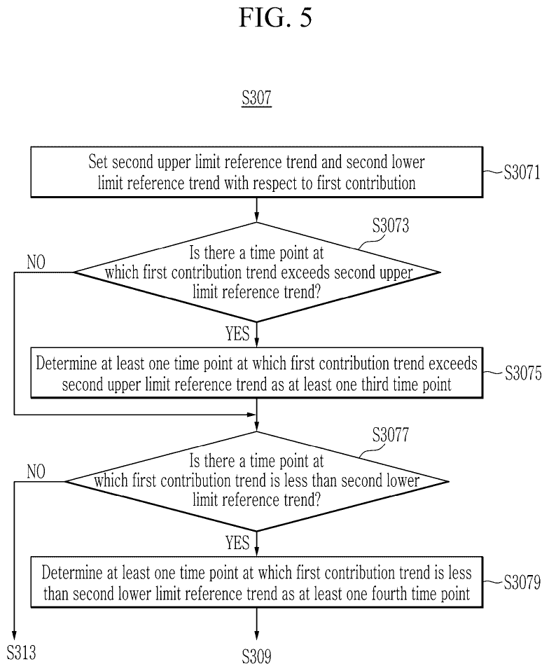

FIG. 3 is a flowchart showing an operation of a defect-causing factor detection circuit according to some embodiments. FIG. 4 is a flowchart showing a step S305 in FIG. 3. FIG. 5 is a flowchart showing a step S307 in FIG. 3.

First, at step S301, the defect-causing factor detection circuit 205 may generate a first process trend with respect to the first process data among the plurality of process data.

At step S303, the defect-causing factor detection circuit 205 may generate a first contribution trend with respect to the yield contribution of the first process data.

In more detail, the defect-causing factor detection circuit 205 may receive the first yield contribution data corresponding to the first process data from the yield prediction model analysis circuit 203. The defect-causing factor detection circuit 205 may generate the first contribution trend based on the first yield contribution data.

At the step S305, the defect-causing factor detection circuit 205 may determine whether the first process trend rapidly changes (e.g., a value of the process data changes such that is outside of a threshold range and/or is greater/less than a threshold value, thereby satisfying a change condition).

In some embodiments, the defect-causing factor detection circuit 205 may determine whether the first process trend rapidly changes based on an auxiliary indicator. For example, when the first process trend with respect to the first process data is above an upper limit value of the auxiliary indicator and/or is below a lower limit value of the auxiliary indicator, the defect-causing factor detection circuit 205 may determine that it rapidly changes.

In more detail, referring to FIG. 4 together, at the step S3051, the defect-causing factor detection circuit 205 may set a first upper limit reference trend and a first lower limit reference trend with respect to the first process data.

In some embodiments, the auxiliary indicator may be Bollinger Bands. The defect-causing factor detection circuit 205 may calculate a moving average, which is a time series average value during a predetermined period of time, and its standard deviation, with respect to each of the plurality of process data EQU_DATA. The defect-causing factor detection circuit 205 may calculate the first upper limit reference trend of the auxiliary indicator by adding K times (here, K is an arbitrary constant) of the standard deviation to the calculated moving average, and may calculate the first lower limit reference trend of the auxiliary indicator by subtracting K times of the standard deviation from the moving average. For example, the predetermined period of time may be 24 hours.

Meanwhile, the present disclosure is not limited thereto, and the defect-causing factor detection circuit 205 may set the first upper limit reference trend and the first lower limit reference trend by using any appropriate auxiliary indicator such as the moving average convergence/divergence (MACD).

At the step S3053, the defect-causing factor detection circuit 205 may determine whether there exists a time point at which the first process trend exceeds the first upper limit reference trend.

In more detail, when a value of the first process trend is above a value of the first upper limit reference trend at a specific time point, the defect-causing factor detection circuit 205 may determine that there exists the time point at which the first process trend exceeds the first upper limit reference trend.

If there does not exist the time point at which the first process trend exceeds the first upper limit reference trend, the step S3057 may be performed.

If there exists the time point at which the first process trend exceeds the first upper limit reference trend, the defect-causing factor detection circuit 205 may determine at least one time point at which the first process trend exceeds the first upper limit reference trend as at least one first time point, at the step S3055.

That is, at the at least one first time point, the value of the first process trend may be greater than the value of the first upper limit reference trend.

At the step S3057, the defect-causing factor detection circuit 205 may determine whether there exists the time point at which first process trend is less than the first lower limit reference trend.

In more detail, when the value of the first process trend is below a value of the first lower limit reference trend at a specific time point, the defect-causing factor detection circuit 205 may determine that there exists the time point at which first process trend is less than the first lower limit reference trend.

If there does not exist the time point at which first process trend is less than the first lower limit reference trend, the step may be terminated at step S313.

In more detail, the defect-causing factor detection circuit 205 determines that the first process trend does not rapidly change, and the step may be terminated at the step S313.

If there exists the time point at which first process trend is less than the first lower limit reference trend, at least one time point at which the first process trend is less than the first lower limit reference trend may be determined as at least one second time point, at the step S3059.

That is, at the at least one second time point, the value of the first process trend may be smaller than the value of the first upper limit reference trend.

Thereafter, the defect-causing factor detection circuit 205 may determine that the first process trend rapidly changes, and the step S307 may be performed.

Referring back to FIG. 3, if the defect-causing factor detection circuit 205 determines that the first process trend rapidly changes, the defect-causing factor detection circuit 205 may determine whether the first contribution trend rapidly changes (e.g., a value of the first contribution trend changes such that is outside of a threshold range and/or is greater/less than a threshold value, thereby satisfying a change condition), at the step S307.

In some embodiments, the defect-causing factor detection circuit 205 may determine whether the first contribution trend rapidly changes based on the auxiliary indicator. For example, when the first contribution trend with respect to the first process data is above the upper limit value of the auxiliary indicator and/or is below the lower limit value of the auxiliary indicator, the defect-causing factor detection circuit 205 may determine that it rapidly changes.

In more detail, referring to FIG. 5, at the step S3071, the defect-causing factor detection circuit 205 may set a second upper limit reference trend and a second lower limit reference trend with respect to a first contribution.

In some embodiments, the auxiliary indicator may be Bollinger Bands. The defect-causing factor detection circuit 205 may calculate a moving average, which is a time series average value during the predetermined period of time, and its standard deviation, with respect to each of the plurality of yield contributions data STEP_DATA with respect to the plurality of process data EQU_DATA. For example, the defect-causing factor detection circuit 205 may calculate a moving average, which is a time series average value of the yield contribution, and its standard deviation, with respect to the plurality of process data EQU_DATA. The defect-causing factor detection circuit 205 may calculate the second upper limit reference trend of the auxiliary indicator by adding L times (here, L is an arbitrary constant) of the standard deviation to the calculated moving average, and may calculate the second lower limit reference trend of the auxiliary indicator by subtracting L times of the standard deviation from the moving average. For example, the predetermined period of time may be 24 hours.

Meanwhile, the present disclosure is not limited thereto, and the defect-causing factor detection circuit 205 may set the second upper limit reference trend and the second lower limit reference trend by using any appropriate auxiliary indicator such as MACD.

At the step S3073, whether there exists a time point at which the first contribution trend exceeds the second upper limit reference trend may be determined.

In more detail, when a value of the first contribution trend is above a value of the second upper limit reference trend at a specific time point, the defect-causing factor detection circuit 205 may determine that there exists the time point at which the first contribution trend exceeds the second upper limit reference trend.

If there does not exist the time point at which the first contribution trend exceeds the second upper limit reference trend, the step S3077 may be performed.

If there exists the time point at which the first contribution trend exceeds the second upper limit reference trend, at least one time point at which the first contribution trend exceeds the second upper limit reference trend may be determined as at least one third time point, at the step S3075.

That is, at the at least one third time point, the value of the first contribution trend may be greater than the value of the second upper limit reference trend.

At the step S3077, whether there exists a time point at which the first contribution trend is less than the second lower limit reference trend may be determined.

In more detail, when the value of the first contribution trend is below a value of the second lower limit reference trend at a specific time point, the defect-causing factor detection circuit 205 may determine that there exists the time point at which the first contribution trend is less than the second lower limit reference trend.

If there does not exist the time point at which the first contribution trend is less than the second lower limit reference trend, the step may be terminated, at the step S313.

In more detail, the defect-causing factor detection circuit 205 determines that the contribution trend does not rapidly change, and the step may be terminated, at the step S313.

If there exists the time point at which the first contribution trend is less than the second lower limit reference trend, the time point at which the first contribution trend is less than the second lower limit reference trend may be determined as a fourth time point, at the step S3079.

That is, at the least one fourth time point, the value of the first contribution trend may be smaller than the value of the second lower limit reference trend.

Thereafter, the defect-causing factor detection circuit 205 may determine that the first contribution trend rapidly changes, and step S309 may be performed.

Thereafter, referring back to FIG. 3, if the defect-causing factor detection circuit 205 determines that the contribution trend rapidly changes, the defect-causing factor detection circuit 205 may determine whether the time point at which the first process trend rapidly changes coincides with (or corresponds to) the time point at which the first contribution trend rapidly changes, at the step S309.

For example, the defect-causing factor detection circuit 205 may determine whether at least one time point among the first time points, which are the time points at which the first process trend exceeds the first upper limit reference trend, coincides with (or corresponds to) one time point among the at least one third time point. The defect-causing factor detection circuit 205 may determine whether the first one time point among the at least one first time point coincides with (or corresponds to) one time point among the at least one fourth time point. In addition, the defect-causing factor detection circuit 205 may determine whether the first one time point among the at least one second time point, which is the time point at which the first process trend is less than the first lower limit reference trend coincides with (or corresponds to) the one time point among the at least one third time point. The defect-causing factor detection circuit 205 may determine whether the first one time point among the at least one second time point coincides with (or corresponds to) the one time point among the at least one fourth time point.

Meanwhile, the present disclosure is not limited thereto, and even if the time points do not precisely coincide with or correspond to each other, if an interval from the at least one first time point and/or the one time point among the at least one second time point to the one time point among the at least one third time point and/or the at least one fourth time point is smaller than a preset interval, the defect-causing factor detection circuit 205 may determine that the time point at which the first process trend rapidly changes coincides with the time point at which the first contribution trend rapidly changes. For example, when the preset interval is 1 hour, and the one time point among the at least one first time point and the one time point among the at least one third time point are within 1 hour, the defect-causing factor detection circuit 205 may determine that the time point at which the first process trend rapidly changes coincides with the time point at which the first contribution trend rapidly changes.

At step S311, when it is determined that the time point at which the first process trend rapidly changes coincides with the time point at which the first contribution trend rapidly changes, the defect-causing factor detection circuit 205 may determine or identify the first process data as the defect candidate data.

The defect-causing factor detection circuit 205 may determine the first process data among the plurality of process data EQU_DATA, in which the time point at which the first process trend rapidly changes coincides with the time point at which the first contribution trend rapidly changes as the defect candidate data DEF_CAN.

The defect-causing factor detection circuit 205 determines or identifies the defect candidate data DEF_CAN based on the first process trend and the first contribution trend, and therefore, may detect not only a factor that typically causes a defect but also an unexpected defect candidate.

When it is determined that the time point at which the first process trend rapidly changes does not coincide with the time point at which the first contribution trend rapidly changes, the step may be terminated, at the step S313.

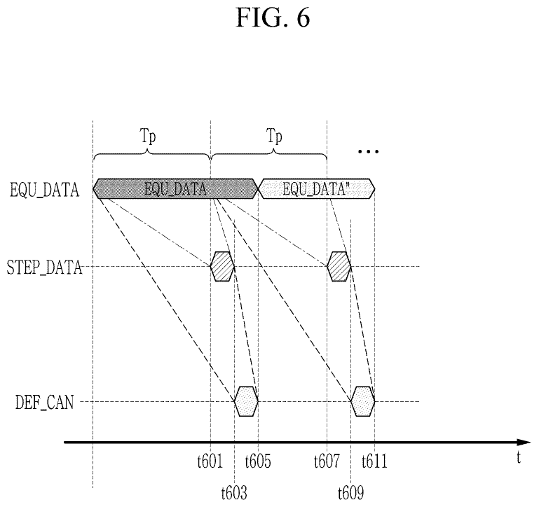

FIG. 6 is a graph showing data generated by a defect candidate detection device over time according to some embodiments.

As shown in FIG. 6, during a reference unit section Tp, the plurality of process facilities 10 may generate the plurality of process data EQU_DATA. The reference unit section Tp may be preset. For example, the reference unit section Tp may be 24 hours.

The defect candidate detection device 20 may receive the plurality of process data EQU_DATA generated during the reference unit section Tp from the plurality of process facilities 10. In some embodiments, the defect candidate detection device 20 may receive the process data accumulated during the reference unit section Tp after the reference unit section Tp has elapsed. For example, the defect candidate detection device 20 may receive the plurality of process data EQU_DATA at a first time point t601. Meanwhile, the present disclosure is not limited thereto, and the defect candidate detection device 20 may receive the process data generated by the plurality of process facilities 10 in real time.

Between the first time point t601 and a second time point t603, the defect candidate detection device 20 may calculate contribution with respect to each of the plurality of process data EQU_DATA based on the received plurality of process data EQU_DATA. Between the first time point t601 and the second time point t603, the defect candidate detection device 20 may generate the yield contribution data STEP_DATA.

Thereafter, between the second time point t603 and a third time point t605, the defect candidate detection device 20 may generate a process trend and a contribution trend based on the yield contribution data STEP_DATA with respect to each plurality of process data EQU_DATA and the plurality of process data EQU_DATA. In addition, the defect candidate detection device 20 may determine whether the process trend and the contribution trend with respect to the plurality of process data rapidly change based on the auxiliary indicator. The defect candidate detection device 20 may generate the defect candidate data DEF_CAN based on whether the process trend and the contribution trend with respect to each of the plurality of process data EQU_DATA rapidly changes.

At the third time point t605, the plurality of process facilities 10 may be selectively controlled, by the defect-causing factor detection circuit 205, based on the defect candidate data DEF_CAN. For example, whether the process data included in the defect candidate data DEF_CAN among the plurality of process data EQU_DATA is actually defective may be determined, and may change the control of the process facility corresponding to the corresponding process data to thereby improve the yield of the wafer. Accordingly, from the third time point t605, the plurality of process facilities 10 may generate the process data EQU_DATA″ changed under the changed control.

In the same way, the defect candidate detection device 20 may receive the plurality of process data EQU_DATA″ generated during a reference unit section Tp (t607 to t611) from the plurality of process facilities 10.

Between a fourth time point t607 and a fifth time point t609, the defect candidate detection device 20 may calculate the yield contribution changed based on the changed process data EQU_DATA″.

Between the fifth time point t609 and a sixth time point t611, the defect candidate detection device 20 may generate the defect candidate data DEF_CAN based on the changed process data EQU_DATA″ and the changed yield contribution.

Meanwhile, a first section t601 to a third section t605 associated with the yield contribution data STEP_DATA and the defect candidate data DEF_CAN may be shorter than the reference unit section Tp. Accordingly, the yield of the wafers manufactured by the plurality of process facilities 10 during the first section t601 to the third section t605 may have smaller influence on the entire yield.

Accordingly, the defect candidate detection device 20 may detect, in a timely manner, data in which the process trend and the contribution trend rapidly change compared to an ordinary normal change distribution, as well as the factor that typically causes a defect.

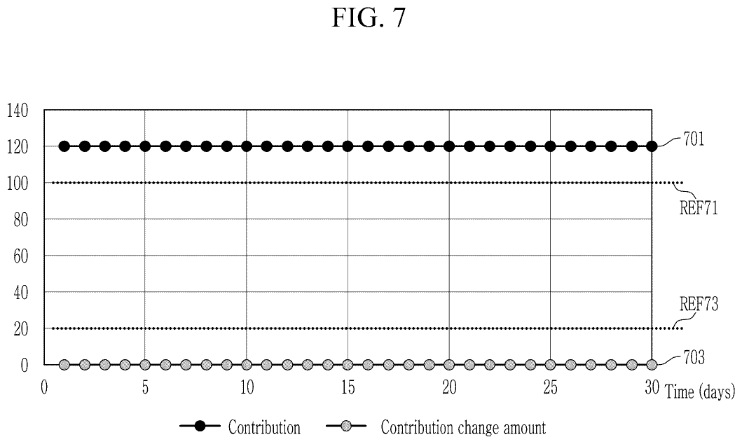

FIG. 7 is a graph illustrating the contribution trend over time.

The first contribution trend 701 is a graph showing the first contribution with respect to the first process data among the plurality of process data EQU_DATA. The first contribution trend 701 may maintain a value of 120, for 30 days.

A first reference trend REF71 may be the preset reference trend with respect to the first contribution. The first reference trend REF71 may have a value of 100.

By comparing the first contribution trend 701 and the first reference trend REF71, if it is determined that the first contribution trend 701 exceeds the first reference trend REF71, the conventional defect candidate detection device determined that the first process data has a high possibility of causing defect. That is, when the first contribution has a value exceeding 100, the defect candidate detection device may determine that the first process data has a high possibility of causing defect. Accordingly, since the first contribution trend 701 maintains the value of 120 exceeding the first reference trend REF71 for 30 days, conventionally, the first process data was determined to be a factor having a high possibility of causing defect for 30 days.

Meanwhile, a second contribution change amount trend 703 is a graph showing the first contribution change amount. As shown in the first contribution trend 701, since the first contribution constantly maintains the value of 120, the second contribution change amount trend 703 may maintain a value of 0.

A second reference trend REF73 may be the preset reference trend with respect to the first contribution change amount. The second reference trend REF73 may have a value of 20.

The defect candidate detection device 20 according to some embodiments may compare the second contribution change amount trend 703 and the second reference trend REF73, and may determine, if the second contribution change amount trend 703 exceeds the second reference trend REF73, that the first process data has a high possibility of causing defect. That is, when the first contribution change amount has a value exceeding 20, the defect candidate detection device 20 may determine that the first process data has a high possibility of causing defect.

Accordingly, since the second contribution change amount trend 703 maintains the value of 0 that does not exceed the second reference trend REF73 for 30 days, the defect candidate detection device 20 may determine that the first process data does not have a high possibility of causing defect.

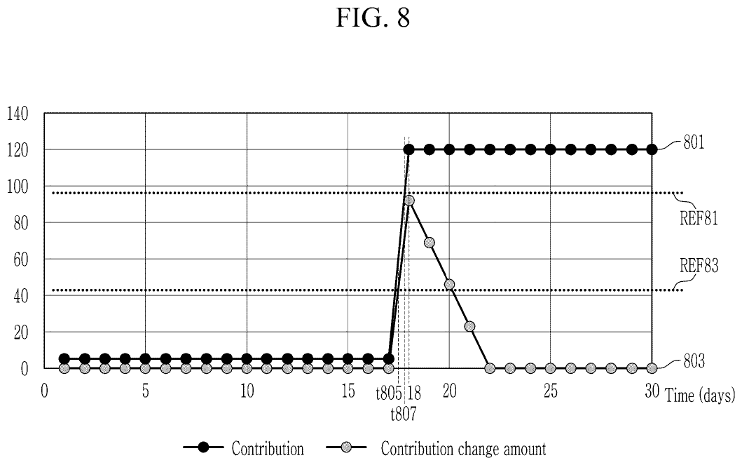

FIG. 8 is a graph illustrating the contribution trend over time.

The first contribution trend 801 is a graph showing the first contribution with respect to the first process data among the plurality of process data EQU_DATA. The first contribution trend 801 may maintain the value of 0 for 17 days, and then may have the value of 120 from the 18th day to the 30th day.

A first reference trend REF81 may be the preset reference trend with respect to the first contribution. The first reference trend REF81 may have the value of 100.

By comparing the first contribution trend 801 and the first reference trend REF81, the conventional defect candidate detection device determined that the first process data has a high possibility of causing defect, if the first contribution trend 801 exceeds the first reference trend REF81. That is, when the first contribution has a value exceeding 100, the defect candidate detection device may determine that the first process data has a high possibility of causing defect. Accordingly, from time point t807, since the first contribution trend 701 maintains the value of 120 exceeding the first reference trend REF71, the first process data was determined to be a factor having a high possibility of causing defect until 30 days from time point t807.

Meanwhile, a second contribution change amount trend 803 is a graph showing the first contribution change amount. As shown in the first contribution trend 801, since the first contribution maintains the value of 0 up to the 17th day and has the value of 120 from the 18th day, the second contribution change amount trend 703 may change from the 17th day. As shown in the second contribution change amount trend 803, the first contribution change amount may start to change from 17th day to have a value of about 100 on the 18th day, and then may gradually decrease from the 18th day to become and maintain the value of 0 from the 22th day to the 30th day.

A second reference trend REF83 may be the reference trend preset with respect to the first contribution change amount. The second reference trend REF83 may have the value of 40.

By comparing the second contribution change amount trend 803 and the second reference trend REF83, the defect candidate detection device 20 according to some embodiments determined that the first process data has a high possibility of causing defect, if the second contribution change amount trend 803 exceeds the second reference trend REF83. That is, when the first contribution change amount has a value exceeding 40, the defect candidate detection device 20 may determine that the first process data has a high possibility of causing defect.

The second contribution change amount trend 703 may maintain the value of 0 that does not exceed the second reference trend REF73 until t805, exceed the second reference trend REF73 from t805 to the 20th day, and then have a value that does not exceed the second reference trend REF73 from the 20th day to the 30th day. Accordingly, the defect candidate detection device 20 may determine that, from t805 to the 20th day, the first process data has a high possibility of causing defect. The defect candidate detection device 20 may not merely continue detecting the factor that typically causes a defect, and may detect data in which the process trend and the contribution trend rapidly change compared to normal change, in a timely manner.

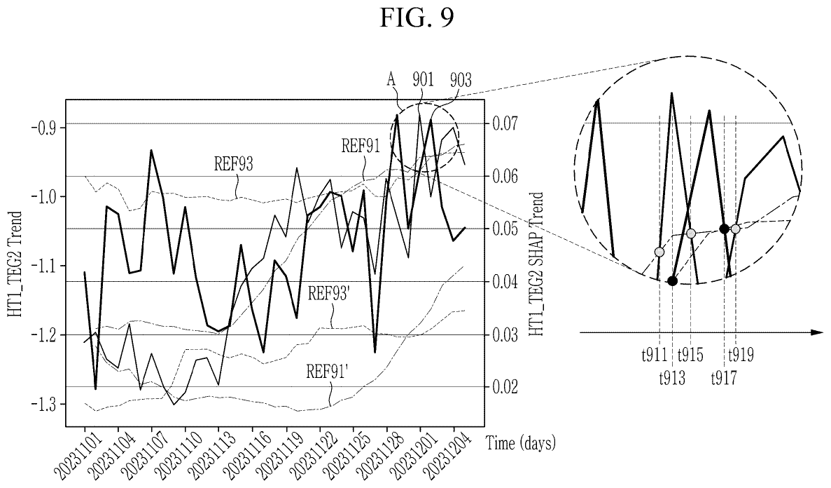

FIG. 9 is a graph illustrating the contribution trend over time.

The first process trend 901 with respect to the first process data is a graph showing the trend with respect to the first process data among the plurality of process data EQU_DATA.

The first upper limit reference trend REF91 may be an upper limit reference trend set with respect to the first process data. For example, the defect candidate detection device 20 may calculate a moving average, which is a time series average value of a first process data, and its standard deviation, and may determine the value obtained by adding K times (here, K is an arbitrary constant) of the standard deviation to the calculated moving average as the upper limit reference trend.

The first lower limit reference trend REF91′ may be a lower limit reference trend set with respect to the first process data. For example, the defect candidate detection device 20 may calculate a moving average, which is a time series average value of the first process data, and its standard deviation, and may determine the value obtained by subtracting K times (here, K is an arbitrary constant) of the standard deviation from the calculated moving average as the lower limit reference trend.

The first contribution trend 903 with respect to the first process data is a graph showing the contribution trend of the first process data among the plurality of process data EQU_DATA with respect to the wafer.

The second upper limit reference trend REF93 may be an upper limit reference trend set with respect to the first contribution. For example, the defect candidate detection device 20 may calculate a moving average, which is a time series average value of the first contribution, and its standard deviation, and may determine the value obtained by adding L times (here, L is an arbitrary constant) of the standard deviation to the calculated moving average as the upper limit reference trend.

The second lower limit reference trend REF93′ may be a lower limit reference trend set with respect to the first contribution. For example, the defect candidate detection device 20 may calculate a moving average, which is a time series average value of the first contribution, and its standard deviation, and may determine the value obtained by subtracting L times (here, L is an arbitrary constant) of the standard deviation from the calculated moving average as the lower limit reference trend.

The defect candidate detection device 20 may determine whether the first process trend 901 rapidly changes. Specifically, the defect candidate detection device 20 may detect a time point at which the first process trend 901 exceeds the first upper limit reference trend REF91, and/or a time point at which the first process trend 901 is less than the first lower limit reference trend REF91′. As shown in a first portion A, for example, the defect candidate detection device 20 may detect time points t911, t915, and t919 at which the first process trend 901 exceeds the first upper limit reference trend REF91.

The defect candidate detection device 20 may determine whether the first contribution trend 903 rapidly changes. Specifically, the defect candidate detection device 20 may detect a time point at which the first contribution trend 903 exceeds the first upper limit reference trend REF93, and/or a time point at which the first contribution trend 903 is a first lower limit reference trend REF93′. As shown in the first portion A, for example, the defect candidate detection device 20 may detect time points t913 and t917 at which the first contribution trend 903 exceeds the first upper limit reference trend REF93.

The defect candidate detection device 20 may determine whether the one time point among the at least one first time point at which the first process trend 901 exceeds the first upper limit reference trend REF91 coincides with the one time point among the at least one second time point at which the first contribution trend 903 exceeds the first upper limit reference trend REF93. In some embodiments, when the one time point among the at least one first time point is below the preset interval from the one time point among the at least one second time point, the defect candidate detection device 20 may determine that the one time point among the at least one first time point coincides with the one time point among the at least one second time point.

In the first portion A, the defect candidate detection device 20 may determine whether the interval from t913 to t911 and/or t915 is smaller than the preset interval, and when it is smaller than the preset interval, it may detect the first process data as the defect candidate data DEF_CAN. The defect candidate detection device 20 may determine whether the interval from t917 to t915 and/or t919 is smaller than the preset interval, and when it is smaller (or less) than the preset interval, it may detect the first process data as the defect candidate data DEF_CAN.

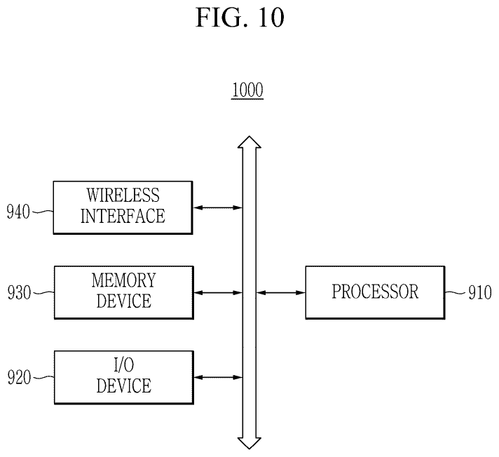

FIG. 10 is a block diagram showing an electronic device according to some embodiments.

Referring to FIG. 10, an electronic device 1000 may include a PDA, a laptop computer, a portable computer, a web tablet, a wireless phone, a mobile phone, a digital music player, a wired/wireless electronic device, or the like. The electronic device 1000 may include a processor 910, input/output device 920 (e.g., keypad, keyboard and/or display), a memory device 930 and a wireless interface 940.

The processor 910 may be implemented as a processing circuit such as hardware including a logic circuit, a hardware/software combination such as processor execution software, or a combination thereof. For example, the processor 910 may include a central processing unit (CPU), microprocessor, a digital signal processor, a micro controller or any other logic device. For example, the logic device may have a function similar to one among a microprocessor, a digital signal processor, and a micro controller.

In some embodiments, the processor 910 may be the defect candidate detection device according to FIG. 1. The processor 910 may detect a factor having the possibility of reducing the yield during the semiconductor manufacturing process. The processor 910 may generate the predicted yield data indicating a predicted yield of the wafer based on the plurality of process data received from the plurality of process facilities. The processor 910 may learn data stored in the memory device 930 to receive the plurality of process data, and output a predicted yield of the wafer corresponding to the plurality of process data. The processor 910 may generate the yield contribution data indicating the degree of influence on the yield of the wafer by the process data based on the process data and the predicted yield data. The processor 910 may determine whether the process data is the defect candidate data having a possibility of yield reduction based on the first process trend indicating the time-series variation of the process data and the first contribution trend indicating the time-series variation of the yield contribution data. Specifically, the processor 910 may set the reference trend with respect to the process data and the yield contribution data, and may determine whether the first process trend and the first contribution trend deviates from the predetermined reference trend. When a time point at which the first process trend deviates from the reference trend coincides with a time point at which the first contribution trend deviates from the reference trend, the processor 910 may determine the corresponding process data as the defect candidate data.

The memory device 930 may store, for example, instructions performed by the processor 910. In addition, the memory device 930 may also be used to store user data.

In some embodiments, the memory device 930 may store a portion of the defect candidate detection device according to FIG. 1. For example, the memory device 930 may store data necessary for training the defect candidate detection device. The memory device 930 may store data including the predicted yield of the wafer corresponding to the plurality of process data.

The electronic device 1000 may use the wireless interface 940 in order to transmit data to a wireless communication network communicating with radio frequency (RF) signal or receive data from the network. For example, the wireless interface 940 may include an antenna or a wireless transceiver. The electronic device 1000 may be used in a communication interface protocol such as a third generation communication system (e.g., CDMA, GSM, NADC, E-TDMA, WCDMA and/or CDMA2000).

In some embodiments, the electronic device 1000 may communicate with the plurality of process facilities through the wireless interface 940. For example, the electronic device 1000 may receive the plurality of process data from the plurality of process facilities through the wireless interface 940.

While this disclosure has been described in connection with what is presently considered to be practical embodiments, it is to be understood that the disclosure is not limited to the disclosed embodiments, but is intended to cover various modifications and equivalent arrangements included within the scope of the appended claims.

What is claimed is:

1. A defect candidate detection device, comprising:
a processor configured to execute computer program instructions, the processor comprising:
a yield prediction model circuit configured to receive a plurality of process data and generate a predicted yield data indicating a predicted yield of a wafer based on the plurality of process data;
a yield prediction model analysis circuit configured to generate a yield contribution data based on the plurality of process data and the predicted yield data, wherein the yield contribution data indicates a degree of influence on a yield of the wafer by each of the plurality of process data; and
a defect-causing factor detection circuit configured to detect a defect candidate data among the plurality of process data based on the plurality of process data and the yield contribution data, wherein the defect candidate data corresponds to a reduction of the yield of the wafer,
wherein the defect-causing factor detection circuit is configured to selectively control a process facility based on the defect candidate data, the process facility comprising equipment that performs or monitors a semiconductor manufacturing process.

2. The defect candidate detection device of claim 1, wherein the defect-causing factor detection circuit is configured to generate:
a first process trend indicating a time-series variation of first process data among the plurality of process data, and
a first contribution trend that indicates a time-series variation of a yield contribution corresponding to the first process data.

3. The defect candidate detection device of claim 2, wherein the defect-causing factor detection circuit is configured to:
determine whether the first process trend satisfies a change condition based on a first reference trend,
determine whether the first contribution trend satisfies the change condition based on a second reference trend, and
when the first process trend and the first contribution trend satisfy the change condition, determine that the first process data is the defect candidate data.

4. The defect candidate detection device of claim 3, wherein:
the first reference trend is based on a first standard deviation and a first moving average, which is a time series average value corresponding to the first process data during a predetermined period of time; and
the second reference trend is based on a second standard deviation and a second moving average, which is a time series average value of the yield contribution data corresponding to the first process data during the predetermined period of time.

5. The defect candidate detection device of claim 3, wherein the defect-causing factor detection circuit is configured to:
determine whether a first time point at which the first process trend deviates from the first reference trend corresponds to a second time point at which the first contribution trend deviates from the second reference trend, and
when the first time point corresponds to the second time point, determine that the first process data is the defect candidate data.

6. The defect candidate detection device of claim 5, wherein the defect-causing factor detection circuit is configured to determine the first process data is the defect candidate data when an interval between the first time point and the second time point is less than or equal to a predetermined interval.

7. The defect candidate detection device of claim 3, wherein the defect-causing factor detection circuit is configured to set the first reference trend and the second reference trend based on at least one of a Bollinger Band or a moving average convergence/divergence (MACD).

8. The defect candidate detection device of claim 1, wherein the yield prediction model circuit is a neural network model trained to output the predicted yield data based on the plurality of process data.

9. The defect candidate detection device of claim 8, wherein the neural network model comprises at least one of Adaptive Boosting (AdaBoost), a Gradient Boosting Machine (GBM), an extra Gradient Boosting (XGBoost), Light Gradient Boosting (LightGBM), a long short-term memory (LSTM), a deep neural network (DNN), a convolutional neural network (CNN), a recurrent neural network (RNN), a bidirectional recurrent deep neural network (BRDNN), a deep knowledge tracing (DKT), a Dynamic Key-Value Memory Networks (DKVMN), Self-Attentive Knowledge Tracing (SAKT), or a decision tree model.

10. The defect candidate detection device of claim 1, wherein the yield prediction model analysis circuit is configured to generate the yield contribution data by applying an explainable artificial intelligence technique to the yield prediction model circuit.

11. An operation method of a defect candidate detection device, comprising:
executing, by at least one processor, computer program instructions to perform operations comprising:
generating a first process trend indicating a time-series variation of a first process data among a plurality of process data;
generating a first contribution trend indicating a time-series variation of a yield contribution indicating a degree of influence on a yield of a wafer by the first process data;
determining whether the first process trend satisfies a change condition;
determining whether the first contribution trend rapidly satisfies the change condition;
determining the first process data is a defect candidate data when the first process trend and the first contribution trend satisfy the change condition, wherein the defect candidate data corresponds to a reduction of the yield of the wafer; and
selectively controlling a process facility based on the defect candidate data, the process facility comprising equipment that performs or monitors a semiconductor manufacturing process.

12. The operation method of claim 11, wherein the determining whether the first process trend satisfies the change condition comprises:
setting a first upper limit reference trend and a first lower limit reference trend that correspond to the first process data;
determining whether the first process trend exceeds the first upper limit reference trend;
determining at least one first time point at which the first process trend exceeds the first upper limit reference trend when the first process trend exceeds the first upper limit reference trend;
determining whether the first process trend is less than the first lower limit reference trend; and
determining at least one second time point at which the first process trend is less than the first lower limit reference trend when the first process trend is less than the first lower limit reference trend.

13. The operation method of claim 12, wherein the determining whether the first contribution trend satisfies the change condition comprises:
setting a second upper limit reference trend and a second lower limit reference trend that correspond to the yield contribution of the first process data;
determining whether the first contribution trend exceeds the second upper limit reference trend;
determining at least one third time point at which the first contribution trend exceeds the second upper limit reference trend when the first contribution trend exceeds the second upper limit reference trend;
determining whether the first contribution trend is less than the second lower limit reference trend; and
determining at least one fourth time point at which the first contribution trend is less than the second lower limit reference trend when the first contribution trend is less than the second lower limit reference trend.

14. The operation method of claim 13, wherein the setting the first upper limit reference trend and the first lower limit reference trend comprises:
determining a first moving average, which is a time series average value of the first process data during a predetermined period of time, and a first standard deviation,
determining the first upper limit reference trend by adding a constant multiple of the first standard deviation to the first moving average; and
determining the first lower limit reference trend by subtracting the constant multiple of the first standard deviation from the first moving average.

15. The operation method of claim 14, wherein the setting the second upper limit reference trend and the second lower limit reference trend comprises:
determining a second moving average, which is a time series average value of the yield contribution with respect to the first process data during the predetermined period of time, and a second standard deviation,
determining the second upper limit reference trend by adding a constant multiple of the second standard deviation to the second moving average; and
determining the second lower limit reference trend by subtracting the constant multiple of the second standard deviation from the second moving average.

16. The operation method of claim 13, wherein the determining first process data is determined to be the defect candidate data comprises when:
a time point among the at least one first time point corresponds to a time point among the at least one third time point, or
a time point among the at least one second time point corresponds to a time point among the at least one fourth time point.

17. The operation method of claim 13, wherein the determining the first process data is the defect candidate data comprises when an interval between a time point among the at least one first time point and the at least one second time point and a time point among the at least one third time point and the at least one fourth time point is less than a predetermined interval.

18. A defect candidate detection system, comprising:
a process facility configured to generate process data indicating at least one of an operation state and a measurement value of the process facility, the process facility comprising equipment that performs or monitors a semiconductor manufacturing process; and
a defect detection device configured to:
generate predicted yield data indicating a predicted yield of a wafer based on the process data,
generate yield contribution data indicating a degree of influence on a yield of the wafer by the process data based on the process data and the predicted yield data,
determine whether the process data is a defect candidate data based on a first contribution trend indicating a first process trend and based on a time-series variation of the yield contribution data indicating a time-series variation of the process data, wherein the defect candidate data corresponds to a reduction of the yield of the wafer, and
selectively control the process facility based on the defect candidate data.

19. The defect candidate detection system of claim 18, wherein the defect detection device is configured to:
set a first reference trend based on a first moving average and a first standard deviation corresponding to the process data,
set a second reference trend based on a second moving average and a second standard deviation corresponding to the yield contribution data, and
when the first process trend deviates from the first reference trend and the first contribution trend deviates from the second reference trend, determine that the process data is the defect candidate data.

20. The defect candidate detection system of claim 19, wherein, when a time point at which the first process trend deviates from the first reference trend corresponds to a time point at which the first contribution trend deviates from the second reference trend, the defect detection device is configured to determine the process data is the defect candidate data.
